(19) United States
(12) Patent Application Publication
(10) Pub. No.: US 2014/0361108 A1
(43) Pub. Date: Dec. 11, 2014

(54) EDGE PROTECTION INSERT MOUNTS FOR GRINDING ROLLS

(71) Applicant: FLSmidth A/S, Valby (DK)

(72) Inventors: Jason Euculano, Northampton, PA (US); Dwayne R. Schantz, Coopersburg, PA (US)

(21) Appl. No.: 14/366,756

(22) PCT Filed: Dec. 13, 2012
(86) PCT No.: PCT/US12/69346

§ 371 Date: Jun. 19, 2014

Related U.S. Application Data
(60) Provisional application No. 61/580,342, filed on Dec. 27, 2011.

(51) Int. Cl. B02C 4/30

(52) U.S. Cl. CPC B02C 4/305; B02C 4/30
USPC 241/294; 29/895.2; 241/300

(57) ABSTRACT

A roller press comprises a roller [100] having: a roller edge [110] formed by the intersection of a roller end [126] and an outer surface [128], an edge wear component [150] provided at said roller edge [110], and a mounting insert [160] provided within a mounting insert pocket [129] located inland of said roller end [126] and spaced from said roller edge [110]. A fastener [140] extends between the edge wear component [150] and the mounting insert [160] to keep the edge wear component [150] attached to the roller [100]. The fastener [140] threadedly engages female threads [164] provided within the mounting insert [160]. Also disclosed, is an edge protection system and method of mounting an edge wear component [150] to a roller [100] in a roller press.

### CROSS-REFERENCE OF RELATED APPLICATIONS

This application is an international application which claims the benefit of U.S. Provisional Patent Application No. 61/580,342, filed on 27 Dec. 2011.

### BACKGROUND OF THE INVENTION

This invention relates to crushing, grinding, and comminution equipment, and more particularly to high pressure grinding roller (HPGR) press systems used, for instance, in the mining, cement, coal, and minerals processing industries.

FIG. 1 shows a conventional edge wear component 950 which is threadedly secured to the edge 910 of a roller sleeve 920 which forms a portion of a roller 900. A series of wear inserts 930 are distributed over an outer surface 928 of the roller sleeve 920 and are disposed within wear insert pockets 922. A fastener 940 having a head 944, a socket 942, and a shaft 946 comprising male threads 948 is inserted into a hole within roller sleeve 920, the hole comprising female threads 924. The head 944 of the fastener fits within a head recess 952 provided within the edge wear component 950 and the shaft 946 extends through a shaft recess 954. An abutment surface 956 of the edge wear component 950 rests against an end 926 of the roller sleeve 920.

In such configurations, the hole having female threads 924 is positioned well below wear insert pockets 922 in order to avoid interferences between the wear inserts 930 and the fastener 940. This lower fastening position makes the edge wear component 950 more susceptible to premature “pull-off” due to larger moment forces, which are created, for instance, when feed and/or autogenous layer material pushes against upper regions of the edge wear component 950.

Currently, when a roller edge 910 erodes, it is repaired by filling gaps, holes, and worn-away material on the roller sleeve 920 with hardface weld material. Subsequent grinding and machining processes on the roller sleeve 920 may be necessary after hardface welding, in order to bring the roller 900 back to original specifications. Such methods are time-consuming, inefficient, and costly. Moreover, with the aforementioned prior art designs, if female threads 924 in the roller shell 920 become stripped by the fastener 940, the roller sleeve 920 needs to be reworked.

Recent attempts have been made to prevent premature edge wear grinding rollers. For instance, KHD and Polysius have pursued roller designs which incorporate the fastening of removable hard bodies to the roller edges (see U.S. Pat. Nos. 7,497,396 and 7,510,135). However, these designs are susceptible to “washout”, where roller sleeve substrate material begins to erode due to the migration of abrasive particles forming the autogenous layer.

### OBJECTS OF THE INVENTION

It is, therefore, an object of the invention to provide a mechanically-robust edge wear component system.

It is also an object of the invention to provide edge wear components having adequate support, stability, and resistance to “pull off”.

It is yet another object of the invention to provide a means for quickly repairing stripped or damaged female threads which would otherwise require the reworking of a roller or sleeve portion thereof.

These and other objects of the invention will be apparent from the drawings and description herein. Although every object of the invention is believed to be attained by at least one embodiment of the invention, there is not necessarily any one embodiment of the invention that achieves all of the objects of the invention.

### SUMMARY OF THE INVENTION

A roller press is disclosed. The roller press comprises a roller having a roller edge formed by the intersection of a roller end and an outer surface. An edge wear component is provided adjacent said roller edge, and a mounting insert is provided within a mounting insert pocket which is located inland of said roller end and spaced from said roller edge. A fastener extends between the edge wear component and the mounting insert to keep the edge wear component attached to the roller. The fastener threadedly engages female threads which are provided within the mounting insert. In some embodiments, the edge wear component may comprise at least one of an end face liner and an outer face liner. In some embodiments, the edge wear component comprises first and second sides that are configured to form a radial weld channel when the first and second sides abut respective second and first sides of adjacent edge wear components in side-by-side relationship. In some embodiments, at least one of said first and second sides comprises a protrusion. In some embodiments, the edge wear component comprises a circumferential weld channel which is configured to accept a bead of weld material. The bead of weld material may help secure the edge wear component to the roller. In some embodiments, the circumferential weld channel comprises a first weld channel face and a second weld channel face for increased surface area. In some embodiments, the edge wear component accepts a plurality of fasteners, wherein at least one of said plurality of fasteners threadedly engages female threads in the mounting insert, and at least one of said plurality of fasteners threadedly engages female threads in another portion of the roller, which may be a roller sleeve. The mounting insert may be cylindrically-shaped, block-shaped, or generally shaped and/or sized similar to other wear inserts provided on the outer surface of the roller. The mounting insert pocket may comprise a blind recess or may alternatively comprise a continuous annular circumferential groove which extends around the roller.

A method of mounting an edge wear component to a roller is also disclosed. The method comprises the steps of: providing a roller having a roller edge formed by the intersection of a roller end and an outer surface, providing a mounting insert pocket located inland of said roller end and spaced from said roller edge, providing a clearance hole extending between the roller end and the mounting insert pocket; providing an edge wear component; providing a mounting insert; positioning said edge wear component adjacent said roller edge; positioning said mounting insert within said mounting insert pocket; aligning the edge wear component with said mounting insert; extending a fastener through said clearance hole and between the edge wear component and the mounting insert; and fixedly engaging the fastener with the mounting insert to keep the edge wear component attached to the roller.

An edge protection system for a roller in a roller press is also disclosed. The edge protection system comprises: an edge wear component; a mounting insert having female threads therein and being configured to be placed within a mounting insert pocket on the roller which is located inland of a roller end; and a fastener configured to extend between the edge wear component and the mounting insert and configured to threadedly engage said female threads within the mounting insert.

### BRIEF DESCRIPTION OF THE DRAWINGS

FIG. 1 is a diametrical cross-sectional view of an edge section of a grinding roller according to the prior art;

FIG. 2 is an end plan view of an edge section of a grinding roller shown in FIG. 1;

FIG. 3 is a diametrical cross-sectional view of an edge section of a grinding roller according to some embodiments;

FIG. 4 is an isometric view of a mounting insert shown in FIG. 3;

FIG. 5 is an end plan view of an edge section of the grinding roller shown in FIG. 3;

FIG. 6 is a diametrical cross-sectional view of an edge section of a grinding roller according to other embodiments;

FIG. 7 is an end plan view of an edge section of the grinding roller shown in FIG. 6;

FIG. 8 is a diametrical cross-sectional view of an edge section of a grinding roller according to yet other embodiments;

FIG. 9 is an isometric view of a block-shaped mounting insert shown in FIG. 8;

FIG. 10 is an end plan view of an edge section of the grinding roller shown in FIG. 8;

FIG. 11 is an isometric view of a grinding roller according to further embodiments;

FIG. 12 is a close-up view of the grinding roller shown in FIG. 11;

FIG. 13 is a large isometric view of a mounting insert in accordance with the embodiment shown in FIGS. 11 and 12;

FIG. 14 is a large isometric view of an edge wear component in accordance with the embodiment shown in FIGS. 11 and 12;

FIG. 15 is an isometric cutaway view of the grinding roller shown in FIG. 11; and,

FIG. 16 is a diametrical cross-sectional view of an edge section of the grinding roller shown in FIG. 15.

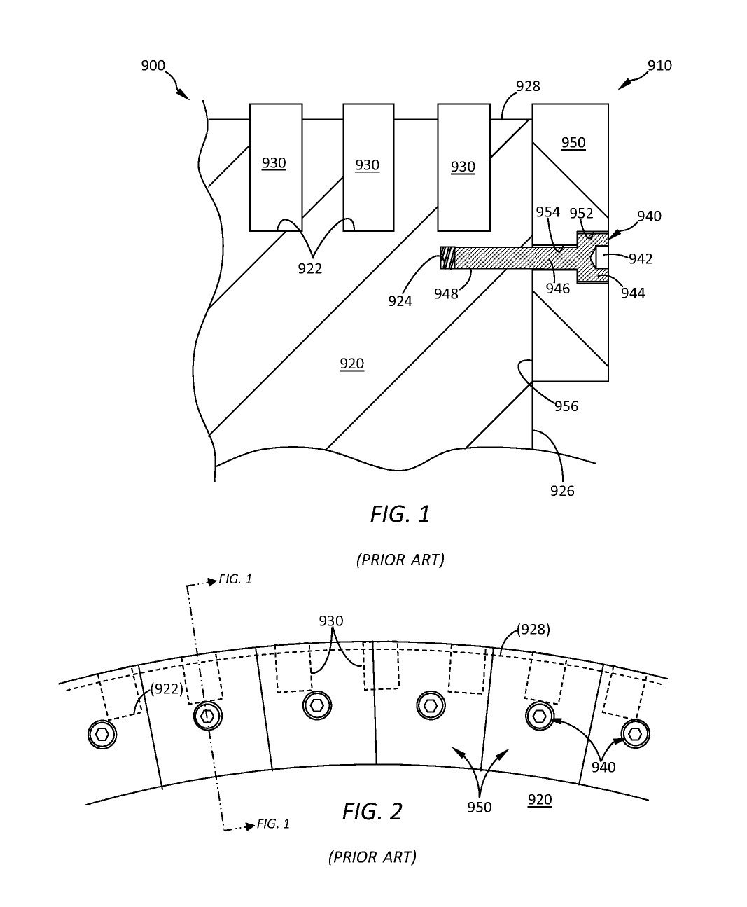

### DETAILED DESCRIPTION OF THE INVENTION

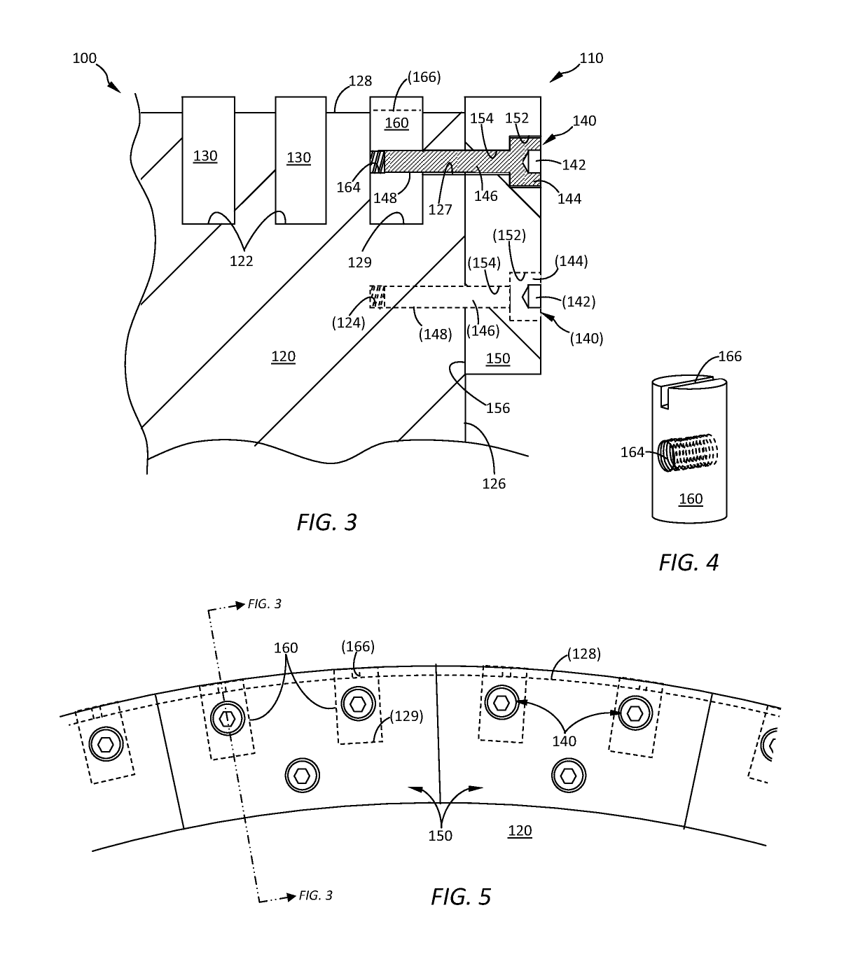

FIGS. 3-5 show a roller 100 according to some embodiments. The roller 100 may comprise a roller sleeve 120 having a roller end 126 and a roller edge 110. An edge wear component 150 may be threadably secured to the edge 110 of the roller sleeve 120. Wear inserts 130 may be distributed over a cylindrical outer surface 128 of the roller sleeve 120 and may be disposed within wear insert pockets 122. A fastener 140 having a head 144, a drive socket 142, and a shaft 146 comprising male threads 148 may be inserted through the edge wear component 150 until the male threads 148 engage female threads 164 provided within a cylindrically-shaped mounting insert 160. The mounting insert 160 may be disposed within a mounting insert pocket 129, and may be provided with an alignment device 166 such as directional indicia or means for rotating the mounting insert 160, in order to align and facilitate threaded engagement between male threads 148 of the fastener 140 and female threads 164 within the mounting insert 160. A clearance hole 127 may be provided in the roller sleeve 120 between the edge wear component 150 and mounting insert 160 in order to make way for the shaft 146 of the fastener 140.

The head 144 of each fastener 140 may fit within a head recess 152 provided on the edge wear component 150 and the shaft 146 of each fastener 140 may extend through a shaft recess 154. An abutment surface 156 of the edge wear component 150 may flushly rest against an end 126 of the roller sleeve 120.

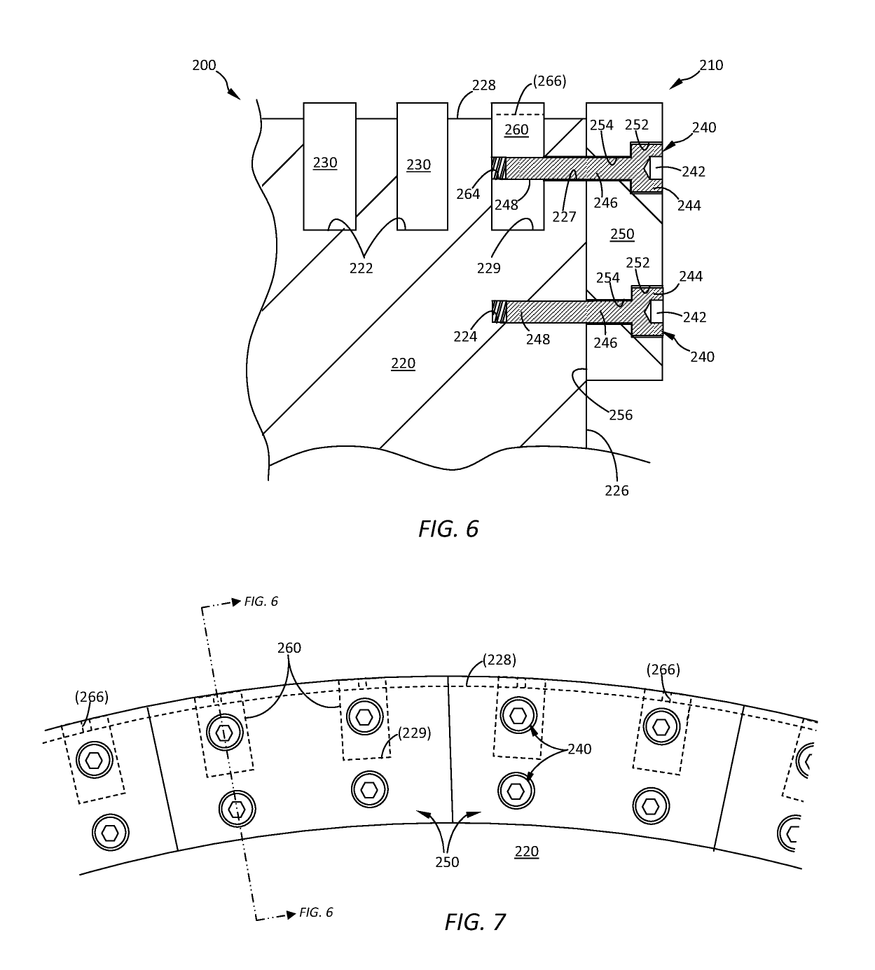

FIGS. 6 and 7 show a roller 200 according to other embodiments. The roller 200 may comprise a roller sleeve 220 having a roller end 226 and a roller edge 210. An edge wear component 250 may be threadably secured to the edge 210 of the roller sleeve 220. Wear inserts 230 may be distributed over a cylindrical outer surface 228 of the roller sleeve 220 and may be disposed within wear insert pockets 222. A fastener 240 having a head 244, a drive socket 242, and a shaft 246 comprising male threads 248 may be inserted through the edge wear component 250 until the male threads 248 engage female threads 264 provided within a mounting insert 260, which may be shaped like other wear inserts 230 (as shown). The mounting insert 260 may be configured to be positioned within a mounting insert pocket 229 in the roller sleeve 220. An alignment device 266 such as directional indicia or means for rotating the mounting insert 260 may be provided to the mounting insert 260, in order to facilitate alignment and threaded engagement between male threads 248 of the fastener 240 and female threads 264 within the mounting insert 260. A clearance hole 227 may be provided in the roller sleeve 220 between the edge wear component 250 and mounting insert 260 in order to make way for the shaft 246 of the fastener 240.

The head 244 of each fastener 240 may fit within a head recess 252 provided on the edge wear component 250 and the shaft 246 of each fastener may extend through a shaft recess 254. An abutment surface 256 of the edge wear component 250 may flushly rest against an end 226 of the roller sleeve 220. Supplemental fasteners 240 may be fixed to female threads 224 provided within the substrate of the roller sleeve 220. In the particular embodiment shown, fasteners 240 are aligned radially along edge wear component 250 in relation to the roller 200, whereas the embodiment shown in FIGS. 3-5 shows fasteners 140 which are staggered and not aligned radially in relation to the roller 100. While not expressly shown in the drawings, embodiments employing combinations of radially-aligned fasteners 240 and staggered fasteners 140 are also envisaged.

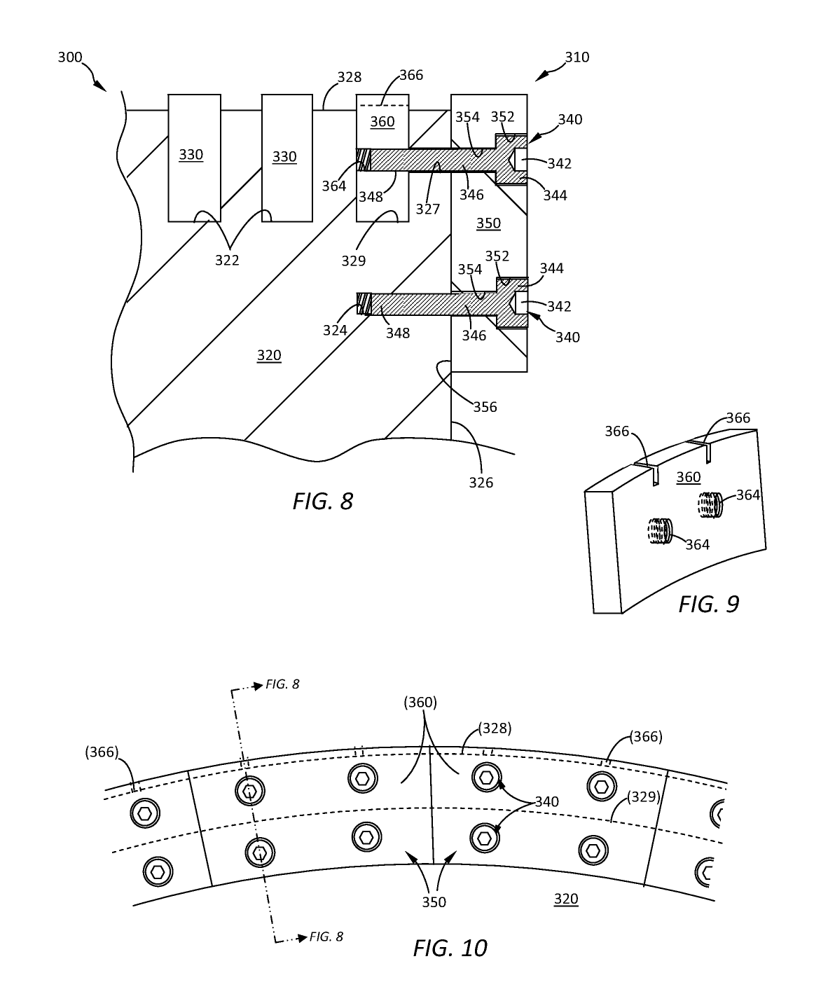

FIGS. 8-10 show a roller 300 according to yet other embodiments. The roller 300 may comprise a roller sleeve 320 having a roller end 326 and a roller edge 310. An edge wear component 350 may be threadedly secured to the edge 310 of the roller sleeve 320. Wear inserts 330 may be distributed over a cylindrical outer surface 328 of the roller sleeve 320 and may be disposed within wear insert pockets 322. A fastener 340 having a head 344, a drive socket 342, and a shaft 346 comprising male threads 348 may be inserted through the edge wear component 350 until the male threads 348 of the fastener engage female threads 364 provided within a block-shaped mounting insert 360. The mounting insert 360 may be provided with an alignment device 366 such as directional indicia or means for indexing the circumferential position of mounting insert 360, in order to align and facilitate threaded engagement between male threads 348 of the fastener 340 and female threads 364 within the mounting insert 360. The mounting insert 360 may be configured to be positioned within a mounting insert pocket 329 in the roller sleeve 320. The mounting insert pocket 329 may comprise individual recesses which are spaced from each other along the outer surface 328, or the mounting insert pocket 329 may comprise a continuous annular groove or channel which surrounds roller sleeve 320 as shown in FIG. 10. A clearance hole 327 may be provided in the roller sleeve 320 between the edge wear component 350 and mounting insert 360 in order to make way for the shaft 346 of the fastener 340. The head 344 of each fastener 340 may fit within a head recess 352 provided within the edge wear component 350 and the shaft 346 of each fastener 340 may extend through a shaft recess 354. An abutment surface 356 of the edge wear component 350 may rest against an end 326 of the roller sleeve 320. Supplemental fasteners 340 may be fixed to female threads 324 provided within the substrate of the roller sleeve 320. In the particular embodiment shown, fasteners 340 are aligned radially along edge wear component 350 in relation to the roller 300.

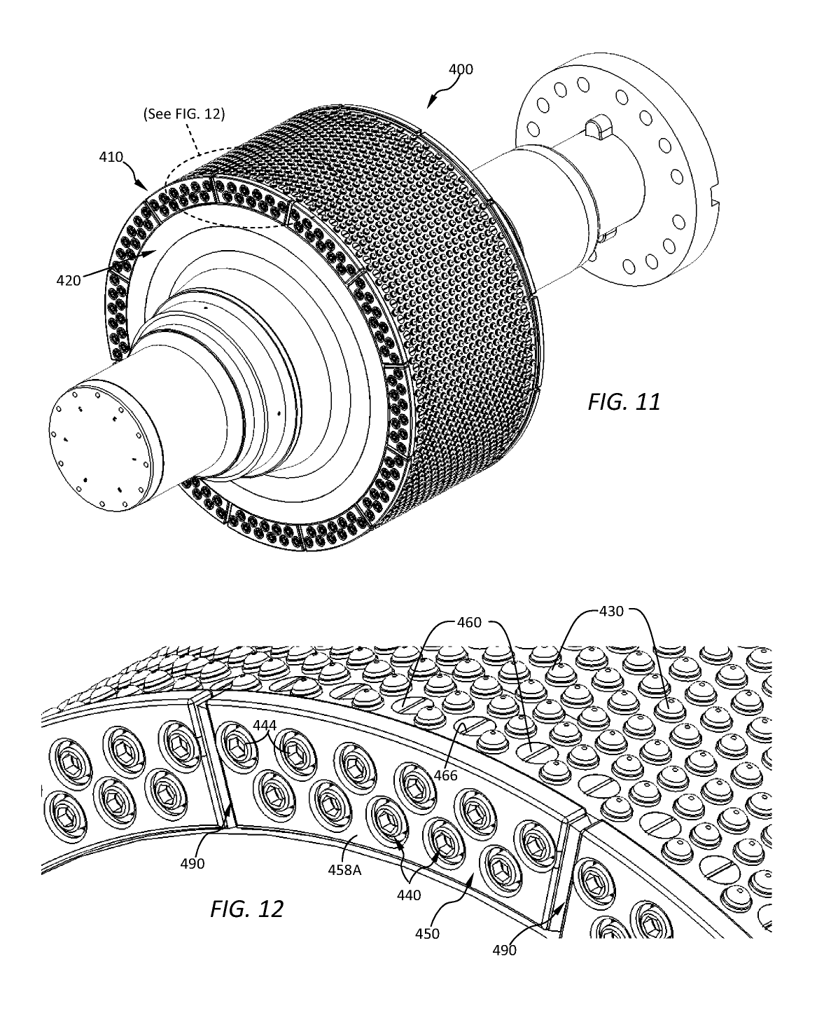

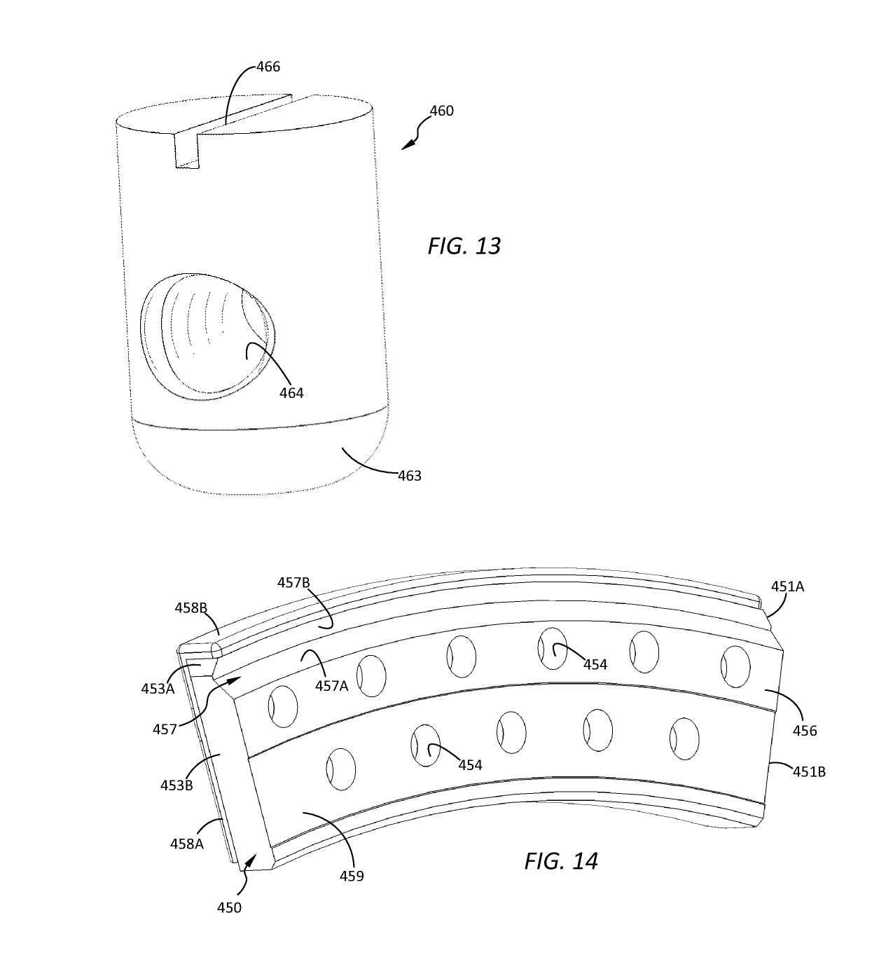

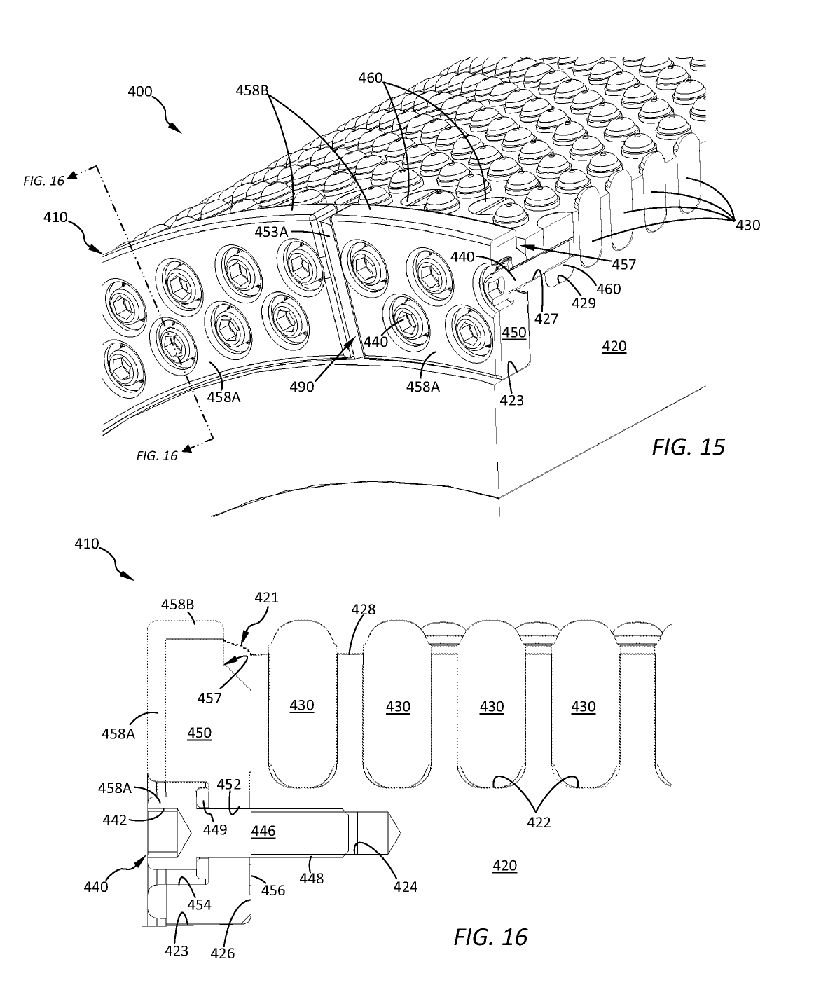

FIGS. 11-16 show a roller 400 according to further embodiments. The roller 400 may comprise a roller sleeve 420 having a recessed roller end 426 and a roller edge 410. The recessed roller end 426 may be recessed from other portions of the roller sleeve 420 as shown, thereby forming a support rim 423. An edge wear component 450 may be threadably secured to the edge 410 of the roller sleeve 420 and supported by the support rim 423. The edge wear component 450 may be recessed so as to not be flush or sit proud with respect to other portions of the roller 100, (e.g., a cylindrical outer surface 428, or the end 426 of roller sleeve 420 as shown). A series of wear inserts 430 may be distributed over the outer surface 428 of the roller sleeve 420 and may be disposed within wear insert pockets 422. A fastener 440 having a head 444 including a drive socket 442 and a shaft 446 comprising male threads 448 may be inserted through the edge wear component 450 until the male threads 448 engage female threads 464 provided within a mounting insert 460. The mounting insert 460 may have a lower chamfer 463 to assist with insertion into and positioning within a mounting insert channel or pocket 429 in the roller sleeve 420. While not shown, the mounting insert 460 may comprise a composite structure, wherein a lower/inner portion of the insert 460 may comprise a softer material and an upper/outer portion of the insert 460 may comprise a harder material. The harder and softer portions may be separately-joined pieces, or may be a monolithic structure having a harness gradient therewithin. The harder upper/outer portion of the insert 460 may provide wear protection, whereas the softer lower/inner portion of the insert 460 may be easier to machine threads designed to engage the male threads 448 of the fastener 440. A clearance hole 427 may be provided in the roller sleeve 420 between the edge wear component 450 and mounting insert 460 in order to make way for the shaft 446 of the fastener 440. An alignment device 466 such as directional indicia may be provided to mounting insert 460.

The head 444 of each fastener 440 may fit within a head recess 452 provided within the edge wear component 450 and the shaft 446 may extend through a shaft recess 454. A washer 449 may be provided within the head recess 452 under the head 444 and surrounding shaft 446. An abutment surface 456 of the edge wear component 450 may rest against an end 426 of the roller sleeve 420. Supplemental fasteners 440 may be fixed to female threads 424 provided within the substrate of the roller 400. In the particular embodiment shown, the fasteners 440 are arranged in a staggered pattern along the edge wear component 450, wherein an upper set of fasteners 440 threadedly engage mounting inserts 460, and a lower set of fasteners 440 threadedly engage roller sleeve 420.

Edge wear components 450 may comprise a circumferential weld channel 457 formed by a first weld channel face 457A which intersects with a second weld channel face 457B. A circumferential weld 421 may be disposed in the circumferential weld channel 457 to further secure the edge wear component 450 to the roller 400. A first side 451B of the edge wear component 450 may comprise a first protrusion 451A, and a second side 453B of the edge wear component 450 may comprise a second protrusion 453A. When edge wear components 450 are abutted circumferentially, in side-by-side relationship, respective first 451A and second 453A protrusions of neighboring edge wear components 450 may communicate to form radial weld channels 490 which may be filled with hardface weld material. As shown, the edge wear component 450 may be formed by fusing, bonding, or otherwise mechanically fastening a harder end face liner 458A and/or a harder outer face liner 458B to a softer body substrate. Fusion of the end face liner 458A and/or harder outer face liner 458B to a softer body substrate may be accomplished using explosion welding, soldering, friction welding, graded powdered metallurgy, heat treatments, adhesives, or other conventional means. One or more recesses or clearance bands 459 may also be provided adjacent the one or more shaft recesses 454, in order to facilitate threaded engagement and deformation compensation between male threads 464 of fasteners 440 and female threads 424 during tightening.

A contractor or other entity may provide a grinding roller, or operate a grinding roll apparatus in whole, or in part, as shown and described. For instance, the contractor may receive a bid request for a project related to designing or operating a grinding roll apparatus, or the contractor may offer to design such a system or a process for a client. The contractor may then provide, for example, any one or more of the devices or features thereof shown and/or described in the embodiments discussed above. The contractor may provide such devices by selling those devices or by offering to sell those devices. The contractor may provide various embodiments that are sized, shaped, and/or otherwise configured to meet the design criteria of a particular client or customer. The contractor may subcontract the fabrication, delivery, sale, or installation of a component of the devices disclosed, or of other devices used to provide said devices. The contractor may also survey a site and design or designate one or more storage areas for stacking the material used to manufacture the devices, or for storing the devices and/or components thereof. The contractor may also maintain, modify, or upgrade the provided devices. The contractor may provide such maintenance or modifications by subcontracting such services or by directly providing those services or components needed for said maintenance or modifications, and in some cases, the contractor may modify a preexisting grinding roll apparatus, or parts thereof with a “retrofit kit” to arrive at a modified grinding roll apparatus comprising one or more method steps, devices, components, or features of the systems and processes discussed herein.

Although the invention has been described in terms of particular embodiments and applications, one of ordinary skill in the art, in light of this teaching, can generate additional embodiments and modifications without departing from the spirit of or exceeding the scope of the claimed. For example, in some embodiments, mounting inserts 160, 260, 360, 460 may comprise softer, more machinable materials than other wear inserts 130, 230, 330, 430. Accordingly, it is to be understood that the drawings and descriptions herein are proffered by way of example to facilitate comprehension of the invention and should not be construed to limit the scope thereof.

### REFERENCE NUMERAL IDENTIFIERS

100, 200, 300, 400, 900 Roller
110, 210, 310, 410, 910 Edge
120, 220, 320, 420, 920 Roller sleeve/tire body
122, 222, 322, 422, 922 Wear insert pocket
124, 224, 324, 424, 924 Female threads
126, 226, 326, 426, 926 End
127, 227, 327, 427 Clearance hole
128, 228, 328, 428, 928 Outer surface
129, 229, 329, 429 Mounting insert pocket
130, 230, 330, 430, 930 Wear insert
140, 240, 340, 440, 940 Fastener
142, 242, 342, 442, 942 Socket
144, 244, 344, 444, 944 Head
146, 246, 346, 446, 946 Shaft
148, 248, 348, 448, 948 Male threads
150, 250, 350, 450, 950 Edge wear component
152, 252, 352, 452, 952 Head recess
154, 254, 354, 454, 954 Shaft recess
156, 256, 356, 456, 956 Abutment surface
160, 260, 360, 460 Mounting insert
164, 264, 364, 464 Female threads
166, 266, 466 Alignment device/Directional indicia/rotational means
421 Circumferential weld
423 Support rim
449 Washer
451A First protrusion
451B First side
453A Second protrusion
453B Second side
457 Circumferential weld channel
457A First weld channel face
457B Second weld channel face
458A End face liner
458B Outer face liner
459 Clearance band
463 Chamfer
490 Radial weld channel

What is claimed is:

1. A roller press comprising:
a roller [100] having a roller edge [110] formed by the intersection of a roller end [126] and an outer surface [128];
an edge wear component [150] provided adjacent said roller edge [110];
a mounting insert [160] provided within a mounting insert pocket [129] located inland of said roller end [126] and being spaced from said roller edge [110]; and
a fastener [140] extending between the edge wear [150] component and the mounting insert [160] to keep the edge wear component [150] attached to the roller [100];
wherein the fastener [140] threadedly engages female threads [164] within the mounting insert [160].

2. The roller press according to claim 1, wherein the edge wear component [150] comprises at least one of an end face liner [458A] and an outer face liner [458B].

3. The roller press according to claim 1, wherein the edge wear component [450] comprises first [451B] and second [453B] sides that are configured to form a radial weld channel [490] when the first [451B] and second [453B] sides abut respective second [453B] and first [451B] sides of adjacent edge wear components [450] in side-by-side relationship.

4. The roller press according to claim 3, wherein at least one of the first [451B] and a second [453B] sides comprise a protrusion [451A, 453A].

5. The roller press according to claim 1, wherein the edge wear component [150] comprises a circumferential weld channel [457] which is configured to accept a bead of weld material.

6. The roller press according to claim 5, wherein the circumferential weld channel [457] comprises a first weld channel face [457A] and a second weld channel face [457B].

7. The roller press according to claim 1, wherein the edge wear component [150] accepts a plurality of fasteners [140], wherein at least one of said plurality of fasteners [140] threadedly engages female threads [164] in the mounting insert [160], and at least one of said plurality of fasteners [140] threadedly engages female threads [124] in another portion of the roller [100].

8. The roller according to claim 7, wherein said another portion of the roller [100] is a roller sleeve [120].

9. The roller according to claim 1, wherein said mounting insert [160] is cylindrically-shaped.

10. The roller according to claim 1, wherein said mounting insert [260] is generally shaped and/or sized similar to other wear inserts [230] provided on the outer surface [228] of the roller [200].

11. The roller according to claim 1, wherein said mounting insert [360] is generally block-shaped.

12. The roller according to claim 1, wherein said mounting insert pocket [129] comprises a blind recess or a continuous annular circumferential groove which extends around the roller [100].

13. A method of mounting an edge wear component [150] to a roller [100] in a roller press comprising:
providing a roller [100] having: a roller edge [110] formed by the intersection of a roller end [126] and an outer surface [128], a mounting insert pocket [129] located inland of said roller end [126] and spaced from said roller edge [110], and a clearance hole [127] extending between the roller end [126] and the mounting insert pocket [129];
providing an edge wear component [150];
providing a mounting insert [160];
positioning said edge wear component [150] adjacent said roller edge [110];
positioning said mounting insert [160] within said mounting insert pocket [129];
aligning the edge wear component [150] with said mounting insert [160];
extending a fastener [140] through said clearance hole [127] and between the edge wear component [150] and the mounting insert [160];
fixedly engaging the fastener [140] with the mounting insert [160] to keep the edge wear component [150] attached to the roller [100].

14. The method according to claim 13, further comprising providing the edge wear component [150] with at least one of an end face liner [458A] and an outer face liner [458B].

15. The method according to claim 13, further comprising providing the edge wear component [450] with first [451B] and second [453B] sides that are configured to form a radial weld channel [490] when the first [451B] and second [453B] sides abut respective second [453B] and first [451B] sides of adjacent edge wear components [450] in side-by-side relationship

16. The method according to claim 15, wherein at least one of the first [451B] and a second [453B] sides comprise a protrusion [451A, 453A].

17. The method according to claim 13, wherein the edge wear component [150] comprises a circumferential weld channel [457] which is configured to accept a bead of weld material.

18. The method according to claim 17, wherein the circumferential weld channel [457] comprises a first weld channel face [457A] and a second weld channel face [457B].

19. The method according to claim 13, further comprising configuring the edge wear component [150] to accept a plurality of fasteners [140], wherein at least one of said plurality of fasteners [140] is configured to threadedly engage female threads [164] in the mounting insert [160], and at least one of said plurality of fasteners [140] is configured to threadedly engage female threads [124] in another portion of the roller [100].

20. The method according to claim 19, wherein said another portion of the roller [100] is a roller sleeve [120].

21. The method according to claim 13, wherein said mounting insert [160] is cylindrically-shaped.

22. The method according to claim 13, wherein said mounting insert [360] is generally shaped and/or sized similar to other wear inserts [330] provided on the outer surface [328] of the roller [300].

23. The method according to claim 13, wherein said mounting insert [360] is generally block-shaped.

24. The method according to claim 13, wherein said mounting insert pocket [129] comprises a blind recess or a continuous annular circumferential groove which extends around the roller [100].

25. An edge protection system for a roller [100] in a roller press comprising:
an edge wear component [150];
a mounting insert [160] having female threads [164] therein and being configured to be placed within a mounting insert pocket [129] on the roller [100] which is located inland of a roller end [126]; and
a fastener [140] configured to extend between the edge wear component [150] and the mounting insert [160] and configured to threadedly engage said female threads [164] within the mounting insert [160].

26. The edge protection system according to claim 25, wherein the edge wear component [150] comprises at least one of an end face liner [458A] and an outer face liner [458B].

27. The edge protection system according to claim 25, wherein the edge wear component [450] comprises first [451B] and second [453B] sides that are configured to form a radial weld channel [490] when the first [451B] and a second [453B] sides abut respective second [453B] and first [451B] sides of adjacent edge wear components [450] in side-by-side relationship.

28. The edge protection system according to claim 27, wherein at least one of the first [451B] and second [453B] sides comprise a protrusion [451A, 453A].

29. The edge protection system according to claim 25, wherein the edge wear component [150] comprises a circumferential weld channel [457] which is configured to accept a bead of weld material.

30. The edge protection system according to claim 29, wherein the circumferential weld channel [457] comprises a first weld channel face [457A] and a second weld channel face [457B].

31. The edge protection system according to claim 25, wherein the edge wear component [150] is configured to accept a plurality of fasteners [140], wherein at least one of said plurality of fasteners [140] is configured to threadedly engage female threads [164] in the mounting insert [160], and at least one of said plurality of fasteners [140] is configured to threadedly engage female threads [124] in another portion of the roller [100].

32. The edge protection system according to claim 25, wherein said mounting insert [160] is cylindrically-shaped.

33. The edge protection system according to claim 25, wherein said mounting insert [360] is shaped and/or sized similar to other wear inserts [330] provided on the outer surface [328] of the roller [300].

34. The edge protection system according to claim 25, wherein said mounting insert [360] is generally block-shaped.
